(19) United States
(12) Patent Application Publication
(10) Pub. No.: US 2021/0119823 A1
(43) Pub. Date: Apr. 22, 2021

(54) SERVER, INFORMATION PROCESSING METHOD, AND NETWORK SYSTEM

(71) Applicant: SHARP KABUSHIKI KAISHA, Osaka (JP)

(72) Inventor: YUKIHIDE SAKO, Osaka (JP)

(21) Appl. No.: 17/071,659

(22) Filed: Oct. 15, 2020

(30) Foreign Application Priority Data
Oct. 18, 2019 (JP) 2019-191195

(51) Int. Cl. H04L 12/28; H04L 12/26

(52) U.S. Cl. CPC H04L 12/2816; H04L 43/0811; H04L 12/2809; H04L 12/2823

(57) ABSTRACT

A server includes: a communication interface configured to communicate with a plurality of electronic devices, a memory configured to accumulate operation information related to the plurality of electronic devices, and a processor configured to cause a plurality of operations of the plurality of electronic devices to be performed, the plurality of operations being repeated during a certain time period in a plurality of days.

### CROSS-REFERENCE TO RELATED APPLICATION

The present application claims priority from Japanese Application JP2019-191195, the content to which is hereby incorporated by reference into this application.

### BACKGROUND OF THE INVENTION

### 1. Field of the Invention

An aspect of the disclosure relates to a technique for controlling home appliances and the like via a network.

### 2. Description of the Related Art

Heretofore, techniques for receiving various provided services via networks have been known. For example, JP 2006-350819 A discloses a home appliance control system.

In JP 2006-350819 A, network home appliances such as an air conditioner and an illuminating lamp which are connected to a domestic network are operated on a screen displayed by a personal computer. In accordance with the operation, an ASP server specifically controls operation of the network home appliances. The screen of the personal computer is provided with buttons, as convenience buttons, corresponding to living scenes, such as “Going out,” “Good night,” and “Welcome back”. For example, when the “Going out” button is operated, the air conditioner is stopped in response, and the illuminating lamp is turned off. Operation of different types of network home appliances can be collectively controlled.

### SUMMARY OF THE INVENTION

An object of an aspect of the disclosure is to allow a plurality of electronic devices to be easily operated.

In accordance with an aspect of the disclosure, a server is provided that includes: a communication interface configured to communicate with a plurality of electronic devices; a memory configured to accumulate operation information related to the plurality of electronic devices; and a processor configured to cause a plurality of operations of the plurality of electronic devices to be performed, the plurality of operations being repeated during a certain time period in a plurality of days.

As described above, according to an aspect of the disclosure, the plurality of electronic devices can be easily operated.

### BRIEF DESCRIPTION OF THE DRAWINGS

FIG. 1 is a conceptual diagram of an overall configuration of a network system 1 according to a first embodiment.

FIG. 2 is a block diagram illustrating a configuration of a server 100 according to the first embodiment.

FIG. 3 is a conceptual diagram illustrating user information data 121 according to the first embodiment.

FIG. 4 is a conceptual diagram illustrating device information data 122 according to the first embodiment.

FIG. 5 is a conceptual diagram illustrating operation information data 123 according to the first embodiment.

FIG. 6 is a conceptual diagram illustrating trigger data 124 according to the first embodiment.

FIG. 7 is a conceptual diagram illustrating operation command group data 125 according to the first embodiment.

FIG. 8 is a flowchart illustrating information processing by the server 100 according to the first embodiment.

FIG. 9 is a block diagram illustrating a configuration of an electronic device 200 according to the first embodiment.

FIG. 10 is a block diagram illustrating a configuration of a communication terminal 300 according to the first embodiment.

FIG. 11 is a conceptual diagram illustrating a setup screen for a trigger operation according to a second embodiment.

FIG. 12 is a flowchart illustrating information processing by the server 100 according to a sixth embodiment.

FIG. 13 is a flowchart illustrating information processing by the server 100 according to the sixth embodiment.

### DETAILED DESCRIPTION OF THE INVENTION

Embodiments of the disclosure will be described below with reference to the drawings. In the following descriptions, identical components are given identical reference signs. Respective names and functions of the components are also identical. Thus, detailed descriptions will not be repeated for the components.

### First Embodiment

### Overall Configuration of Network System 1

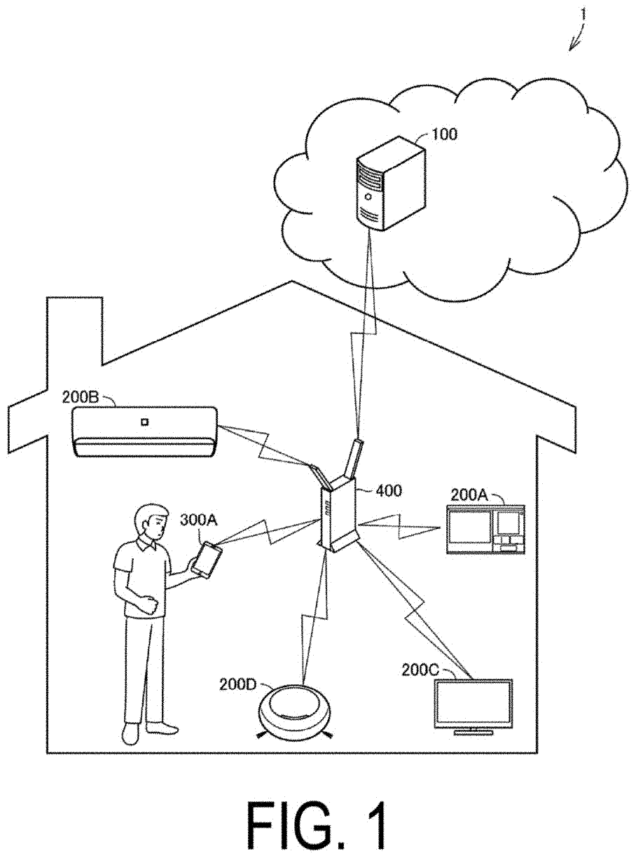

First, with reference to FIG. 1, an overall configuration of the network system 1 will be described. The network system 1 according to the present embodiment mainly includes a server 100, electronic devices such as a microwave oven 200A, an air conditioner 200B, a television 200C, and a cleaning machine 200D, and a communication terminal such as a smartphone 300A.

Note that the electronic devices are not limited to the microwave oven 200A, the air conditioner 200B, the television 200C, the cleaning machine 200D, or the like, but may also include home appliances such as a refrigerator, a laundry machine, an air purifier, a humidifier, a dehumidifier, an automatic cooking pot, a rice cooker, and illumination, a personal computer, Audio Visual (AV) devices such as a hard disk recorder, a projector, a music player, a gaming machine, and a speaker, HEMS facilities such as a solar power generation system, a battery system, and a hot-water supply system, home appliances such as built-in illumination, an intercom, an electronic lock, a water heater, and a warm-water washing toilet seat controller, and the like. Hereinafter, these electronic devices are also collectively referred to as an electronic device 200.

The communication terminal is not limited to the smartphone 300A, and may be a personal computer, a tablet, a gaming machine, a speaker, a wearable terminal, or the like. Hereinafter, these communication terminals are also collectively referred to as a communication terminal 300.

### Operational Overview of Network System 1

Now, with reference to FIG. 1, an operational overview of the network system 1 according to the present embodiment will be described. With respect to the network system 1 according to the present embodiment, a plurality of servers 100 on a cloud provide various services. For example, a user can install an application for home appliance control in the communication terminal 300 and use the communication terminal 300 to remotely control the various electronic devices 200 or to acquire operation information or environment information regarding the electronic device 200.

In particular, in the present embodiment, the server 100 collects various data regarding the plurality of electronic devices 200 possessed by the user to automatically transmit operation commands to the plurality of electronic devices 200. More specifically, the server 100 finds a more likely combination for a plurality of operation commands for a plurality of the electronic devices 200, and when an operation command for the electronic device 200 included in the combination is input, transmits operation commands to other electronic devices included in the combination.

For example, the server 100 recognizes, for a certain user or home, a combination of, between 22 o'clock and 23 o'clock every night, turning off illumination of a living room, turning off illumination of a kitchen, turning off the television, setting the set temperature of the air conditioner to 27° C., turning on the light of the bedroom, and reproducing classical music from the speaker. Thus, between 22 o'clock and 23 o'clock, in a case of acquiring an operation log indicating that the illumination of the living room has been turned off, the server 100 automatically turns off the illumination of the kitchen, turns off the television, sets the set temperature of the air conditioner to 27° C., turn on the light of the bedroom, and reproduces the classical music from the speaker.

In this way, in the network system 1 according to the present embodiment, operations that are simple and that are tailored to the user can be performed on the plurality of electronic devices 200 based on the operation of the user. Hereinafter, a specific configuration of the network system 1 for achieving such a function will be described in detail.

### Configuration of Server 100

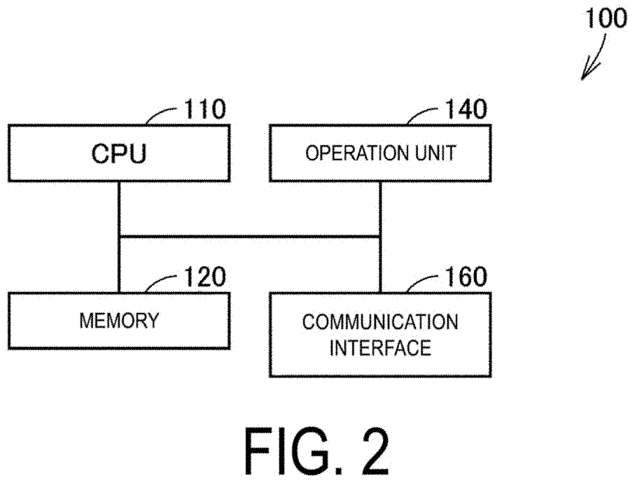

First, an aspect of a configuration of the server 100 configuring the network system 1 according to the present embodiment will be described. As illustrated in FIG. 2, the server 100 includes a Central Processing Unit (CPU) 110, a memory 120, an operation unit 140, and a communication interface 160 as main components.

The CPU 110 controls each unit of the server 100 by executing programs stored in the memory 120. For example, the CPU 110 performs various types of processing, which will be described below, by executing programs stored in the memory 120 and referring to various types of data.

The memory 120 may be practically configured by various types of Random Access Memory (RAM), various types of Read-Only Memory (ROM), and the like. The memory 120 may be embedded in the server 100, may be removably attached to various interfaces of the server 100, or may be a recording medium of another device accessible from the server 100. The memory 120 stores the programs that are executed by the CPU 110, data generated as a result of the CPU 110 executing the programs, input data, other databases used for services relating to the present embodiment, and the like.

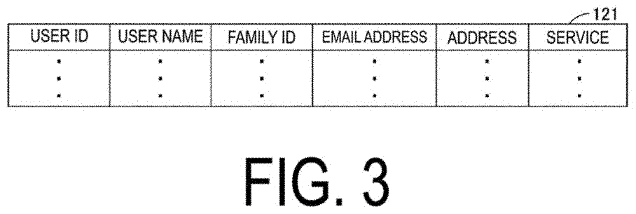

For example, the memory 120 stores user information data 121, as illustrated in FIG. 3. The user information data 121 stores, for each user, a user ID, a user name, a family ID, an email address, an address, a password, identification information regarding various services to which a user is subscribed, the contents of the services, and the like.

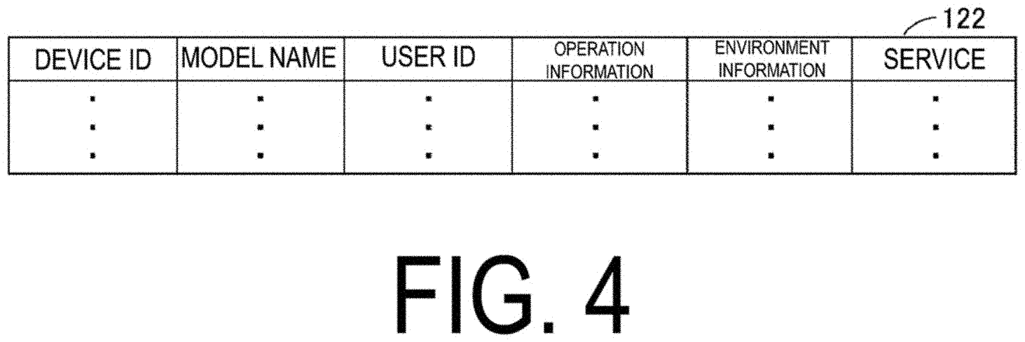

The memory 120 stores device information data 122 as illustrated in FIG. 4. The device information data 122 stores, for each electronic device, a device ID, a type of the device, a user ID of the owner, information regarding an operation in execution, environment information, identification information regarding various services for which the electronic device is registered, the contents of the services, and the like.

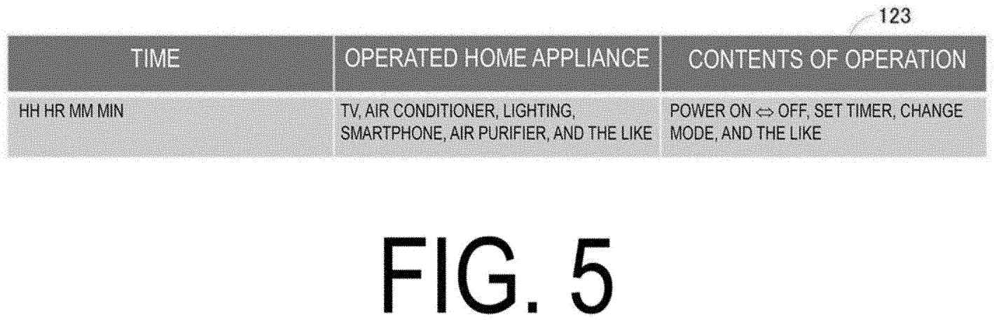

The memory 120 stores operation information data 123, as illustrated in FIG. 5. Each time an operation is performed, the operation information data 123 stores an operated electronic device, the date and time of the operation, and the contents of a command for the operation, and the like, i.e., an operation history.

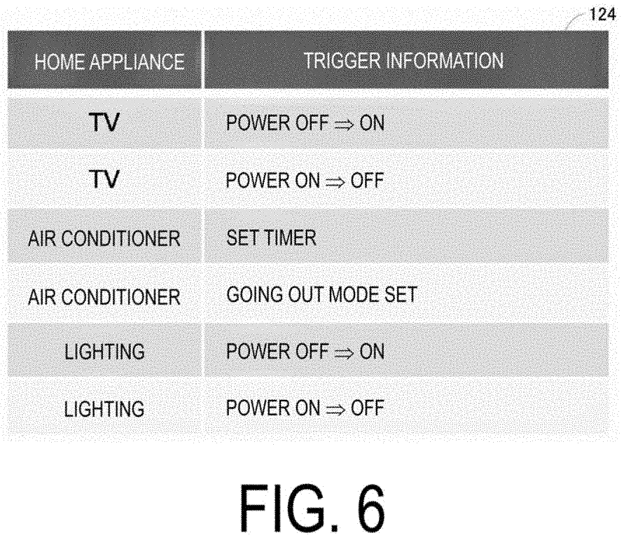

The memory 120 stores the trigger data 124 as illustrated in FIG. 6. The trigger data 124 includes a correspondence relationship between electronic devices to be operated and operation commands corresponding to trigger information used as a trigger for creating a group corresponding to an operation command combination or a trigger for automatically triggering the operation command combination.

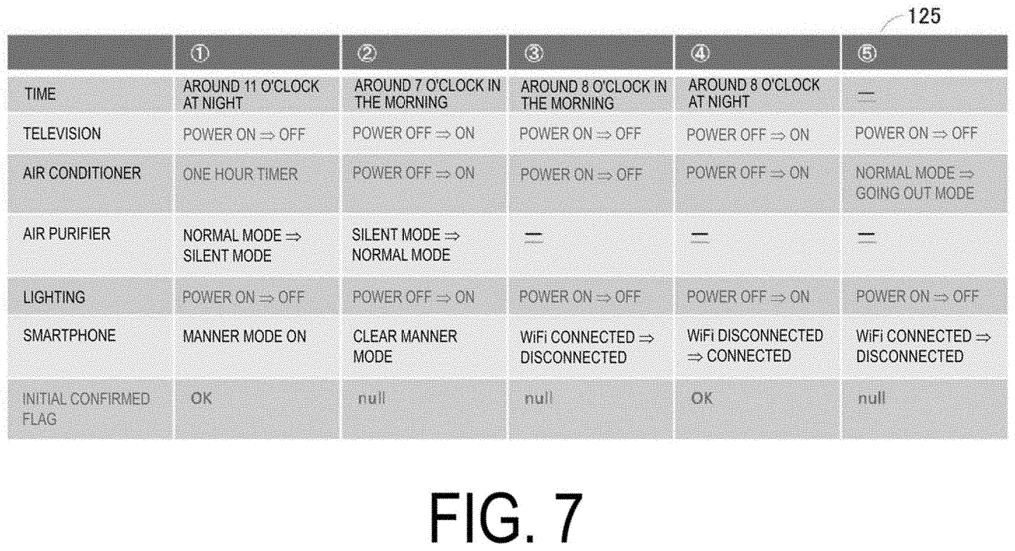

The memory 120 stores operation command group data 125, as illustrated in FIG. 7. The operation command group data 125 stores, for each operation command group, i.e., for each likely combination of a plurality of operation commands with a plurality of electronic devices 200, a time period, a combination of a plurality of operation targets and a plurality of operation commands, and a flag indicating whether the user has provided confirmation. In the present embodiment, prescribed operations for the television, the air conditioner, and lighting are each set as a trigger. Other operations are not used as triggers but are automatically executed because the operations are included in the operation command group.

The data 121 to 125 are not limited to the form described above, and it is sufficient that data such as users, electronic devices to be operated, operation commands, triggering conditions, and the like are associated with one another.

Returning to FIG. 2, the operation unit 140 receives commands from a service administrator and the like, and inputs the commands to the CPU 110.

The communication interface 160 transmits data from the CPU 110 to the other apparatuses such as the electronic devices 200 and the communication terminal 300 via the Internet, a carrier network, a router, or the like. On the other hand, the communication interface 160 receives data from the other apparatuses such as the electronic devices 200 and the communication terminal 300 via the Internet, the carrier network, the router, or the like and transfers the data to the CPU 110.

### Information Processing by Server 100

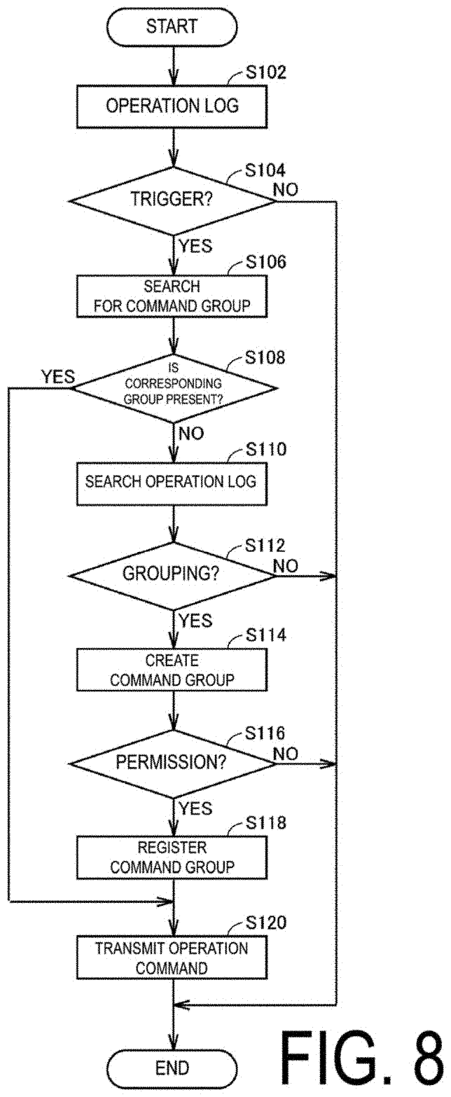

Now, information processing in the server 100 will be described with reference to FIG. 8. The CPU 110 of the server 100 according to the present embodiment executes the following processing in accordance with programs in the memory 120 when receiving data from the communication terminal 300.

First, when acquiring an operation command from the electronic device 200 via the communication interface 160, the CPU 110 stores the operation command in the operation information data 123 (step S102).

The CPU 110 references the trigger data 124 to determine whether the current operation command corresponds to a trigger (step S104). In a case where the current operation command does not correspond to a trigger (in a case of NO in step S104), the CPU 110 terminates the current processing.

In a case where the current operation command corresponds to a trigger (in a case of YES in step S104), the CPU 110 references the operation command group data 125 to search for an operation command combination corresponding to the current point in time and including the operation commands for the trigger, i.e., the operation command group (step S106).

In a case where an operation command group corresponding to the current point in time and including the matching operation commands is found (in a case of YES in step S106), the CPU 110 transmits the operation command to each of the plurality of electronic devices 200 included in the group via the communication interface 160 (step S120).

In a case where no operation command group corresponding to the current point in time and including the matching operation commands is found (in a case of NO in step S106), the CPU 110 references the operation information data 123 and in regard to days from the current date back to the date a number of days before the current date, an input of the operation command corresponding to a trigger is searched for within a prescribed time from the current point in time, for example, within 15 minutes before and after the current point in time (step S110).

The CPU 110 determines whether a combination of a plurality of operation commands with the plurality of electronic devices 200, i.e., an operation command group, can be created (step S112). For example, the CPU 110 references the operation information data 123 to determine, in regard to the days from the current date back to the date a prescribed number of days, for example, 10 days before the current date, whether an operation command similar to the current operation command has been received a prescribed number of times, e.g., six or more times, within a prescribed time from the current point in time, e.g., within 15 minutes before and after the current point in time.

In a case where a group can be created, in regard to the days from the current date back to the date the prescribed number of days before the current date, the CPU 110 organizes, into an operation command group, operation commands corresponding to triggers and operation commands other than the triggers which commands are included within a prescribed time from the current point in time (step S114).

The CPU 110 causes a message indicating a plurality of electronic devices 200 to be operated and a plurality of operation commands for the electronic devices to be output, via the communication interface 160, to the electronic devices 200 or the communication terminal 300 owned by the user of the electronic devices 200, to inquire whether the plurality of operation commands may be executed (step S116).

In a case where permission is not obtained from the user (in a case of NO in step S116), the CPU 110 terminates the current processing.

In a case where permission is obtained from the user (in a case of YES in step S116), the CPU 110 collectively registers operation commands corresponding to triggers and operation commands other than the triggers which commands are included within a prescribed time from the current point in time, for the operation command group data 125 as an operation command group (step S118).

The CPU 110 transmits a plurality of operation commands via the communication interface 160 to the respective electronic devices 200 included in the group (step S120).

### Configuration of Electronic Device 200

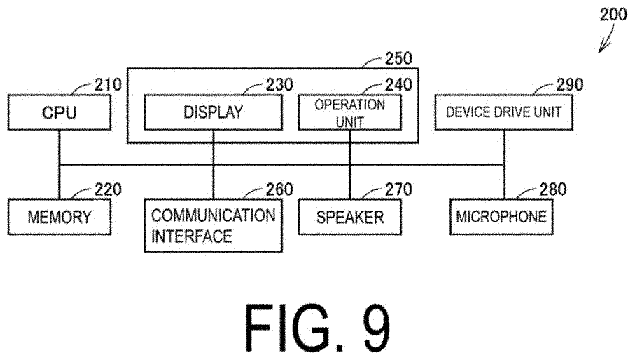

Now, with reference to FIG. 9, an aspect of a configuration of the electronic device 200 included in the network system 1 will be described. The electronic device 200 according to the present embodiment includes a CPU 210, a memory 220, a display 230, an operation unit 240, a communication interface 260, a speaker 270, a microphone 280, and a device drive unit 290 as main components.

The CPU 210 executes a program stored in a memory 220 or an external storage medium to control units of the electronic device 200.

The memory 220 may be practically configured by various types of RAMs, various types of ROMs, and the like. The memory 220 may be embedded in the electronic device 200, may be removably attached to various interfaces of the electronic device 200, or may be a recording medium of another device accessible from the electronic device 200. The memory 220 stores programs executed by the CPU 210, data generated by executing the programs by CPU 210, data input via the operation unit 240, data received from a remote controller, data received from the server 100 via a router 400 and the Internet, information necessary to utilize various services, such as a server address corresponding to the electronic device 200, and the like.

The display 230 outputs characters, images, and the like based on signals from the CPU 210. Note that the display 230 may simply be an LED light or the like.

The operation unit 240 is practically configured by a button, a touch panel, and the like, receives commands from the user, and inputs the commands to the CPU 210. Note that the display 230 and the operation unit 240 may be included in the touch panel 250.

The communication interface 260 is practically configured by an antenna configured to perform wireless communication, a connector configured to perform wired communication, and the like. The CPU 210 utilizes the communication interface 260 to exchange various types of data with the server 100, any other electronic device 200, the communication terminal 300, or the like via the router 400, the Internet, and the like. For example, the CPU 210 transmits the operation commands input from the user to the server 100 via the communication interface 260, or receives the operation commands from the server 100.

The speaker 270 outputs voice messages and the like based on voice data from the CPU 210. The microphone 280 acquires the voice of the user and the like and inputs the voice data to the CPU 210.

The device drive unit 290 controls each unit (such as a motor, a heater, a sensor, an antenna, or the like) of the electronic device 200 based on signals from the CPU 210. For example, for the microwave oven 200A, the units include an antenna or a rotary table for heat-cooking, or for the air conditioner 200B, the units include a compressor and a fan.

### Configuration of Communication Terminal 300

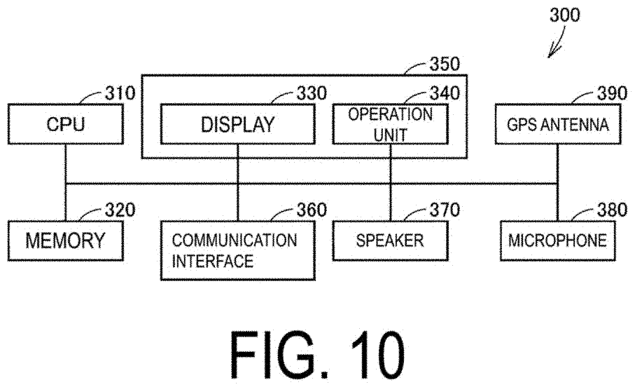

Now, with reference to FIG. 10, an aspect of a configuration of the communication terminal 300 included in the network system 1 will be described. The communication terminal 300 according to the present embodiment includes a CPU 310, a memory 320, a display 330, an operation unit 340, a communication interface 360, a speaker 370, a microphone 380, and a GPS antenna 390 as main components.

The CPU 310 controls each unit of the communication terminal 300 by executing a program stored in the memory 320.

The memory 320 is practically configured by various types of RAM, various types of ROM, and the like. The memory 320 stores application programs for various services, an application program for a notification agent, data generated by the CPU 310 executing the programs, data received from the server 100, data input via the operation unit 340, information used to identify the user of the communication terminal 300, and the like.

The display 330 displays images and text on the basis of the data from the CPU 310. The operation unit 340 includes a pointing device, a switch, and the like, and allows various types of commands from the user to be input into the CPU 310. Note that a user terminal may include a touch panel 350 including the display 330 and the operation unit 340.

The communication interface 360 transmits and/or receives data to and/or from other apparatuses such as the server 100 and the electronic devices 200, via the Internet, the carrier network, the router 400, or the like. For example, the CPU 310 exchanges various types of information related to the electronic devices 200 with the server 100 via the communication interface 360 in accordance with the program for home appliance control. The CPU 310 can receive various services by providing the various types of information to other application programs.

The speaker 370 outputs various voice messages, based on voice data from the CPU 310. The microphone 380 acquires the voice of the user and the like and inputs the voice data to the CPU 310.

The GPS antenna 390 receives radio signals from satellites and transfers the signals to the CPU 310. The CPU 310 acquires the current location based on a GPS signal.

In the present embodiment, the CPU 310 acquires various pieces of information from the server 100 via the communication interface 360. The CPU 310 utilizes the information regarding the current location of the user, calendar information, weather forecast information, user preferences, and the like, to acquire image data and voice data via the communication interface 360 and to output the acquired image data and voice data from the display 330 and the speaker 370, in accordance with various application programs.

Note that the CPU 310 preferably audibly outputs, via the speaker 370, a proposal for a collective operation command from the server 100, receives the collective operation command for the plurality of electronic devices 200 via the microphone 380, and receives a permission command or a prohibition command for the proposal of the collective operation command.

Note that the CPU 310 may receive registration of operation commands for the plurality of electronic devices 200 for each type of collective operation command, via the operation unit 340 as a manual operation from the user. The CPU 310 transmits, to the server 100 via the communication interface 360, registration information regarding the operation commands for the plurality of electronic devices 200 for each type of collective operation command. The CPU 110 of the server 100 receives the registration information via the communication interface 160, and registers, for the operation command group data 125, the operation commands for the plurality of electronic devices 200 on a user-ID-by-user-ID basis and on a family-ID-by-family-ID basis.

### Second Embodiment

In the embodiment described above, with reference to the operation command group data 125, an operation command group is searched for that corresponds to a time period similar to the current point in time and that includes matching operation commands corresponding to triggers (step S106 in FIG. 8), and a determination is made as to whether the operation command corresponding to a trigger has been received a prescribed number of times during a prescribed period of time in the last few days (step S112).

However, for example, in step S108, CPU 110 may determine whether a prescribed number of operation commands corresponding to the trigger have been accepted, such as two, for example. In other words, in a case where a group is found that corresponds to a time period similar to the current point in time and that includes a plurality of types of operation commands corresponding to triggers (in a case of YES in step S108), the CPU 110 may transmit, via the communication interface 160, a plurality of operation commands included in the group to each of the plurality of electronic devices 200 included in the group (step S120).

In step S112, the CPU 110 may reference the operation information data 123 to determine, in regard to the days from the current date back to the date the prescribed number of days before the current date, whether an operation command corresponding to a trigger that is similar to the current operation command has been received a prescribed number of times or more within a prescribed time from the current point in time, and in regard to the days from the current date back to the date the prescribed number of days before the current date, whether another operation command corresponding to a trigger has been received a prescribed number of times within a prescribed time from the current point in time. In other words, the CPU 110 may perform grouping in a case where a combination with a plurality of types of operation commands corresponding to triggers has been received a prescribed number of times.

### Third Embodiment

In the embodiments described above, in regard to the date a prescribed number of days before the current date, an operation command group is searched for that corresponds to the current point in time and that includes the matching operation commands corresponding to triggers (step S106 in FIG. 8), and in regard to the date a prescribed number of days before the current date, whether the operation command corresponding to a trigger has been received a prescribed number of times or more during a prescribed time period (step S112).

However, in step S106, based on the current day of the week, the CPU 110 may search for an operation command group for the same time period on the same day of the week. For example, in the present embodiment, in the operation command group data 125, at least the day of the week is associated with the time period for each operation command group.

In step S112, the CPU 110 may reference the operation information data 123, and based on the current day of the week, determine, in regard to the date a prescribed number of days before the current date on the same day of the week, whether a plurality of types of operation commands corresponding to triggers which are similar to the current operation commands each have been received a prescribed number of times within a prescribed time from the current point in time.

### Fourth Embodiment

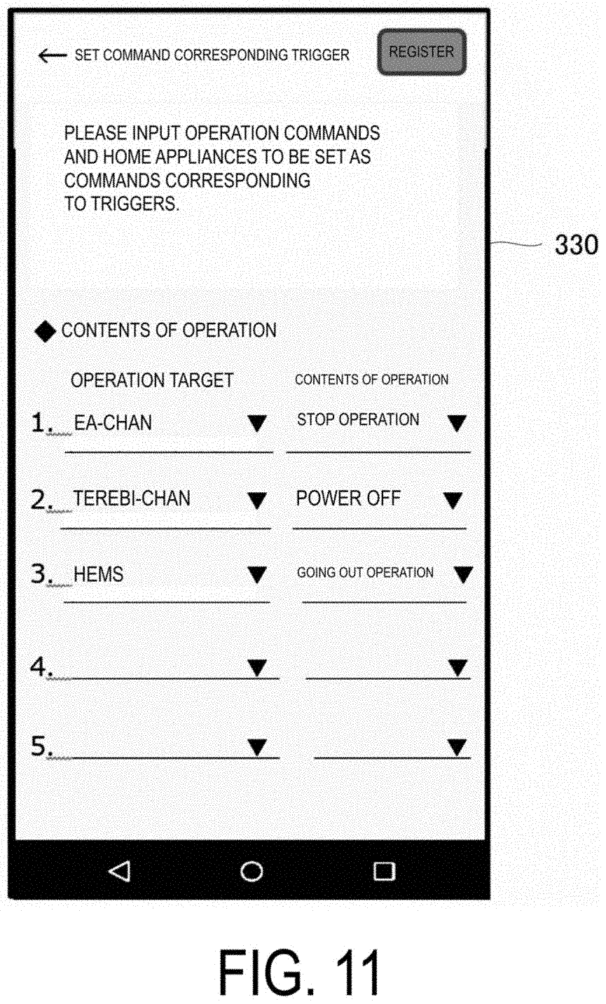

In the embodiments described above, the trigger data 124 is predetermined. However, the types of operation commands corresponding to triggers may be set on a user-by-user basis. For example, as illustrated in FIG. 11, the communication terminal 300 of the user may receive the electronic devices 200 of interest and the operation commands corresponding to triggers and transmit the electronic devices 200 and the operation commands to the server 100. The server 100 registers the types of operation commands corresponding to triggers, in the user information data 121 or the like on a user-by-user basis.

### Fifth Embodiment

In the above-described embodiments, the CPU 110 causes the message indicating the plurality of operation commands and the electronic devices 200 to be operated, which are included in the group, to be output via the communication interface 160 to the electronic devices 200 or the communication terminal 300 owned by the user of the electronic devices 200, to inquire whether the plurality of operation commands may be executed (step S116 in FIG. 8).

However, in step S116, the CPU 110 may transmit the plurality of operation commands to the respective electronic devices 200 included in the group being currently created, via the communication interface 160, and may cause a message inquiring whether the collective operation command as being currently in execution may be automatically input to be output via the communication interface 160 to the electronic devices 200 or the communication terminal 300 owned by the user of the electronic devices 200. Then, in a case where the permission is obtained from the user (in a case of YES in step S116), the CPU 110 collectively registers the operation commands corresponding to triggers and the operation commands other than the triggers which are included within a prescribed time from the current point in time, in the operation command group data 125 as an operation command group (step S118).

Alternatively, in step S116, the CPU 110 may cause a message inquiring whether usual operation commands may be automatically input to be output via the communication interface 160 to the electronic devices 200 or the communication terminal 300 owned by the user of the electronic devices 200. Then, in a case where the permission is obtained from the user (in a case of YES in step S116), the CPU 110 collectively registers the operation commands corresponding to triggers and the operation commands other than the triggers which are included within a prescribed time from the current point in time, in the operation command group data 125 as an operation command group (step S118).

### Sixth Embodiment

In the above-described embodiments, in a case where permission is obtained from the user in step S116, the CPU 110 subsequently transmits the plurality of operation commands to the respective electronic devices 200 included in the group via the communication interface 160 without performing a step of obtaining permission from the user (step S120).

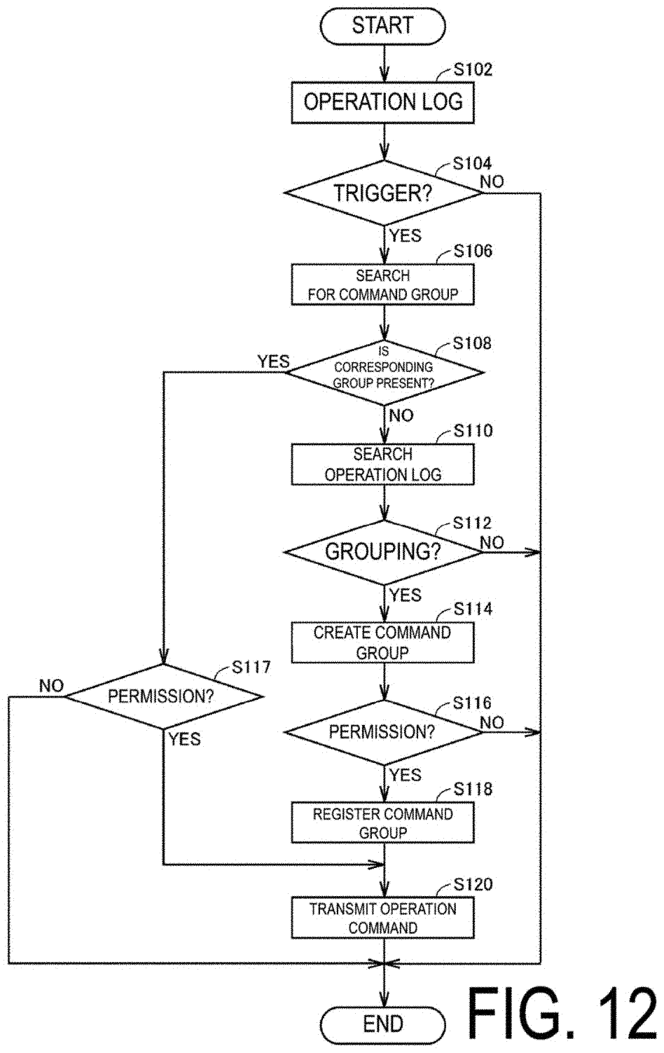

However, as illustrated in FIG. 12, each time an operation command group corresponding to the current point in time and including the matching operation commands is found (in a case of YES in step S106), the CPU 110 may cause the message indicating the plurality of operation commands and the electronic devices 200 to be operated, which are included in the group, to be output via the communication interface 160 to the electronic devices 200 or the communication terminal 300 held by the user of the electronic devices 200, to inquire whether the plurality of operation commands may be executed (step S117).

Then, in a case where permission is obtained from the user (in a case of YES in step S117), the CPU 110 transmits, via the communication interface 160, the plurality of operation commands to the respective electronic devices 200 included in the group (step S120).

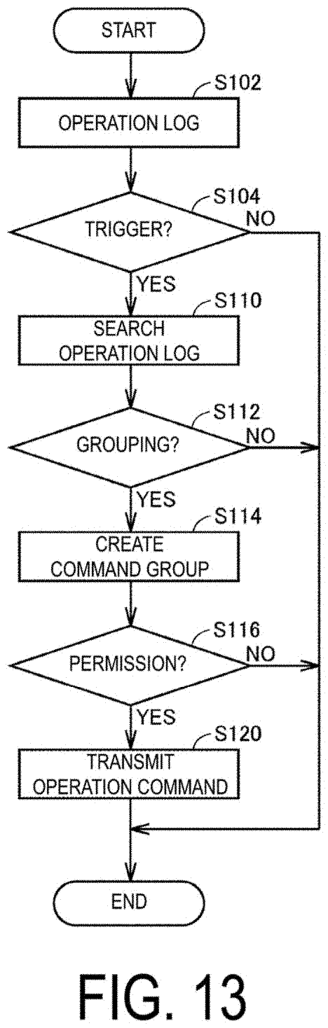

Alternatively, as illustrated in FIG. 13, whether to transmit the plurality of operation commands or not may be determined each time without registration of a group.

More specifically, when acquiring an operation command from the electronic device 200 via the communication interface 160, the CPU 110 stores the operation command in the operation information data 123 (step S102).

The CPU 110 references the trigger data 124 to determine whether the current operation command corresponds to a trigger (step S104). In a case where the current operation command does not correspond to a trigger (in a case of NO in step S104), the CPU 110 terminates the current processing.

In a case where the current operation command corresponds to a trigger (in a case of YES in step S104), the CPU 110 references the operation information data 123 to search for operation commands corresponding to triggers in regard to the date a number of days before the current date and within a prescribed time from the current point in time, for example, within 15 minutes before or after the current point in time (step S110).

The CPU 110 determines whether a group of the plurality of operation commands for the plurality of electronic devices 200 can be created (step S112). For example, the CPU 110 references the operation information data 123 to determine, in regard to the days from the current date back to the date a prescribed number of days, for example, 10 days before the current date, whether an operation command similar to the current operation command has been received a prescribed number of times, e.g., six or more times, within a prescribed time from the current point in time, e.g., within 15 minutes before and after the current point in time. Note that, as in the above-described embodiments, whether at least a prescribed number of commands corresponding to triggers are matched a prescribed number of times or more may be determined.

In a case where a group can be created, in regard to the days from the current date back to the date a prescribed number of days before the current date, the CPU 110 organizes, into a group of operation commands, the operation commands corresponding to triggers and the operation commands other than the triggers which are included within a prescribed time from the current point in time (step S114).

The CPU 110 causes the message indicating the plurality of operation commands and the electronic devices 200 to be operated, which are included in the group, to be output via the communication interface 160 to the electronic devices 200 or the communication terminal 300 owned by the user of the electronic devices 200, to inquire whether the plurality of operation commands may be executed (step S116).

In a case where permission is not obtained from the user (in a case of NO in step S116), the CPU 110 terminates the current processing.

In a case where permission is obtained from the user (in a case of YES in step S116), the CPU 110 transmits the plurality of operation commands to the respective electronic devices 200 included in the group via the communication interface 160 (step S120).

### Seventh Embodiment

In the embodiments described above, when receiving the data of the operation information from the electronic device 200, the CPU 110 executes the subsequent processing. However, the CPU 110 may periodically execute processing from step S104 with no data received from the electronic devices 200.

### Eighth Embodiment

Some or all of the roles of each of the devices of the network system 1 in the above-described embodiments may be performed by other devices. For example, some or all of the roles of each of the server 100, the electronic devices 200, and the communication terminal 300 may be performed by other devices, or a part or all of each of the roles of the apparatuses may be shared among a plurality of apparatuses.

For example, some or all of the roles of the server 100 may be played by a plurality of servers on a cloud, or some or all of the roles of the server 100 may be played by the electronic devices 200 or the communication terminal 300.

### Supplement

In the embodiments described above, a server is provided that includes: a communication interface configured to communicate with a plurality of electronic devices; a memory configured to accumulate operation information related to the plurality of electronic devices; and a processor configured to cause a plurality of operations of the plurality of electronic devices to be performed, the plurality of operations being repeated during a certain time period in a plurality of days.

Preferably, when one of the plurality of operations is input to one of the plurality of electronic devices during the certain time period, the processor causes the plurality of electronic devices to perform the plurality of operations by utilizing the communication interface.

Preferably, after permission is obtained from a user of the plurality of electronic devices via one of the plurality of electronic devices or another communication terminal, the plurality of electronic devices are caused to perform the plurality of operations.

Preferably, in a case of obtaining the permission, the processor subsequently causes the plurality of electronic devices to perform the plurality of operations by utilizing the communication interface without obtaining the permission.

Preferably, the plurality of days are a plurality of days of the same day of the week.

Preferably, the processor references operation information to group the plurality of operations of the plurality of electronic devices repeated during the certain time period on the plurality of days, and stores grouped operations in the memory.

Preferably, the processor performs grouping when a prescribed number or more of prescribed types of operations of the plurality of electronic devices are identified, the operations being repeated during the certain time period on the plurality of days.

Preferably, in a case where the prescribed number of the prescribed types of operations are identified, the processor includes operations other than the prescribed types of operations into the grouping.

Preferably, the processor utilizes the communication interface to receive a designation of the prescribed types of operations via one of the plurality of electronic devices or the another communication terminal.

Preferably, an information processing method in a server is provided that includes: accumulating, in a memory, operation information based on information from a plurality of electronic devices; identifying, by a processor, a plurality of operations of the plurality of electronic devices, the plurality of operations being repeated during a certain time period on a plurality of days; and causing the plurality of electronic devices to perform the plurality of operations via a communication interface.

Preferably, a network system is provided that includes: a plurality of electronic devices configured to transmit operation information; and a server configured to accumulate operation information as a log, to identify a plurality of operations of the plurality of electronic devices, the plurality of operations being repeated during a certain time period on a plurality of days, and to transmit a plurality of operation commands to the plurality of electronic devices.

The embodiments disclosed here are to be understood as being in all ways exemplary and in no ways limiting. The scope of the disclosure is defined not by the foregoing descriptions but by the appended claims, and is intended to include all changes equivalent in meaning and scope to the claims.

What is claimed is:

1. A server comprising:
a communication interface configured to communicate with a plurality of electronic devices;
a memory configured to accumulate operation information related to the plurality of electronic devices; and
a processor configured to cause a plurality of operations of the plurality of electronic devices to be performed, the plurality of operations being repeated during a certain time period in a plurality of days.

2. The server according to claim 1,
wherein when one of the plurality of operations is input to one of the plurality of electronic devices during the certain time period, the processor causes the plurality of electronic devices to perform the plurality of operations by utilizing the communication interface.

3. The server according to claim 1,
wherein after permission is obtained from a user of the plurality of electronic devices via one of the plurality of electronic devices or another communication terminal, the plurality of electronic devices are caused to perform the plurality of operations.

4. The server according to claim 3,
wherein in a case of obtaining the permission, the processor subsequently causes the plurality of electronic devices to perform the plurality of operations by utilizing the communication interface without obtaining the permission.

5. The server according to claim 1,
wherein the plurality of days are a plurality of days of the same day of the week.

6. The server according to claim 1,
wherein the processor references operation information to group the plurality of operations of the plurality of electronic devices repeated during the certain time period on the plurality of days, and stores grouped operations in the memory.

7. The server according to claim 6,
wherein the processor performs grouping when a prescribed number or more of prescribed types of operations of the plurality of electronic devices are identified, the operations being repeated during the certain time period on the plurality of days.

8. The server according to claim 7,
wherein in a case where the prescribed number of the prescribed types of operations are identified, the processor includes operations other than the prescribed types of operations into the grouping.

9. The server according to claim 8,
wherein the processor utilizes the communication interface to receive a designation of the prescribed types of operations via one of the plurality of electronic devices or the another communication terminal.

10. An information processing method in a server, the information processing method comprising:
accumulating, in a memory, operation information based on information from a plurality of electronic devices;
identifying, by a processor, a plurality of operations of the plurality of electronic devices, the plurality of operations being repeated during a certain time period on a plurality of days; and
causing the plurality of electronic devices to perform the plurality of operations via a communication interface.

11. A network system comprising:
a plurality of electronic devices configured to transmit operation information; and
a server configured to accumulate operation information as a log, to identify a plurality of operations of the plurality of electronic devices, the plurality of operations being repeated during a certain time period on a plurality of days, and to transmit a plurality of operation commands to the plurality of electronic devices.
